(19) United States
(12) Patent Application Publication
(10) Pub. No.: US 2003/0205899 A1
(43) Pub. Date: Nov. 6, 2003

(54) Coupling

(76) Inventors: John P. Bishop, Canton, OH (US); Gregary A. Calderone, Canton, OH (US); Leland J. Dick, Medina, OH (US); James F. Smith, Louisville, OH (US)

Correspondence Address: SAND & SEBOLT, AEGIS TOWER, SUITE 1100, 4940 MUNSON STREET, NW, CANTON, OH, 44718-3615, US

(21) Appl. No.: 10/430,064

(22) Filed: May 5, 2003

Related U.S. Application Data
(60) Provisional application No. 60/378,272, filed on May 6, 2002.

(51) Int. Cl. F16L 19/00

(52) U.S. Cl. 285/373; 285/419

(57) ABSTRACT

A coupling for coupling a pair of axially aligned adjacent pipes. The coupling including a substantially cylindrical sleeve having an inner surface including a recess therein where the cylindrical sleeve has a first end area and a second end area. The second end area includes a tab extending therefrom that is selectively alignable and insertable within the recess. A liner may be positioned along the inner surface of the sleeve.

### BACKGROUND OF THE INVENTION

1. Technical Field

The invention relates generally to a coupler or coupling for connecting axially aligned passages and, more particularly, to a pipe coupling for fluidly sealingly connecting two adjacent axially aligned pipes. Specifically, the invention relates to a pipe coupling for use in generally low pressure or low vacuum applications for coupling a pair of axially aligned adjacent pipes, where the pipe coupling includes a substantially cylindrical sleeve having an inner surface including a recess therein where the cylindrical sleeve has a first end area and a second end area, where the second end area includes a tab extending therefrom that is selectively alignable and insertable within the recess.

2. Background Information

As is well known, pipes or other enclosed passages are used to transport all types of gaseous, liquid and even solid media. The types of gaseous, liquid, solid, slurry, or other mixtures that may be transported using pipes and other passages is almost unlimited, and may include sawdust being removed from a wood shop, flour being transported to another processing step during manufacture at a flour mill, chicks being moved within a brooder, slurries being transported for disposal or reclamation, and so on. In many applications, the system is under low pressure or vacuum, or none at all, and may or may not required a sealed or enclosed passage.

In all of the above and many other applications, the pipes or other passages are manufactured and sold in sections or lengths out of convenience in manufacturing, shipping, storage, lifting and ultimately use in many limited space locations. Often multiple pipes or passages are needed in series to get from a first point to a second point, that is to move the material to be transported via an enclosed passage from the first point to the second point. Where multiple pipes or passages are needed, a coupler or coupling is typically one method of connecting the ends of the multiple pipes or passages together, particularly when the one end of each pipe is adjacent and axially aligned.

One version of a prior art coupling is shown in FIGS. 1-3. This prior art coupling includes a metal sleeve or outer layer with a rubber liner therein. The metal sleeve must overlap itself thus causing an off-round cross section to the coupling as best shown by the enlarged inset shown in FIG. 3. This creates a stress point for both the metal sleeve and the rubber liner.

Often a static strip is also required for grounding whereby the static strips function to electrically connect the coupling to the adjacent pipes which are seated within the coupling against the rubber liner. This static strip provides a potential leak path.

These and the other couplings patented, developed and marketed have to varying degrees satisfied some of the needs and desires of users. However, each tends to have some problems and difficulties.

The need thus exists for an improved coupling that addresses the problems of the prior art devices and also provides for improvements.

### BRIEF SUMMARY OF THE INVENTION

In view of the foregoing, advantages are obtained by the improved coupling of the present invention, the general nature of which may be stated as including a coupling for coupling a pair of axially aligned adjacent pipes where the coupling includes a substantially cylindrical sleeve having an inner surface including a recess therein where the cylindrical sleeve has a first end area and a second end area, whereby the second end area includes a tab extending therefrom that is selectively alignable and insertable within the recess.

### BRIEF DESCRIPTION OF THE DRAWINGS

The preferred embodiment of the invention, illustrative of the best mode in which applicant has contemplated applying the principles of invention, is set forth in the following description and is shown in the drawings and is particularly and distinctly pointed out and set forth in the appended claims.

FIG. 1 is a perspective view of one form of prior art;

FIG. 2 is an end view of the prior art coupling shown in FIG. 1;

FIG. 3 is an enlarged sectional view of the wall of the prior art coupling of FIGS. 1-2 showing the outer layer overlap;

FIG. 4 is a general schematic of a piping system for moving materials from a first point to a second point where the piping system requires multiple pipes coupled together using the coupling of the present invention;

FIG. 5 is a perspective view of the coupling of the present invention;

FIG. 6 is an exploded view of the coupling of the present invention as shown in FIG. 5;

FIG. 7 is a top view of the coupling of the present invention of FIGS. 56;

FIG. 8 is a side view of the coupling of the present invention of FIGS. 5-7;

FIG. 9 is an end view of the coupling of the present invention of FIGS. 5-8;

FIG. 10 is an enlarged end view of a portion of the coupling of the present invention of FIGS. 5-9;

FIG. 11 is a sectional view taken along lines 11-11 in FIG. 9 with pipes also sectionally shown and added therein; and

FIG. 12 is a process view of the metal sleeve portion of the coupling of the present invention prior to forming it into a substantially cylindrical sleeve.

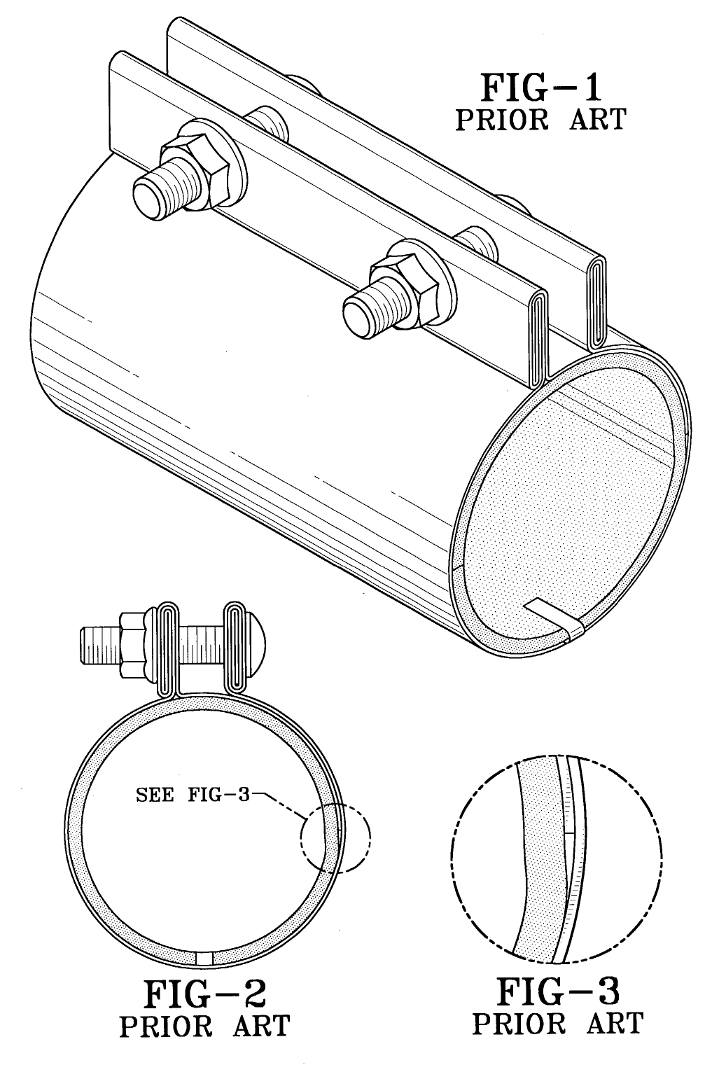

### DETAILED DESCRIPTION OF THE INVENTION

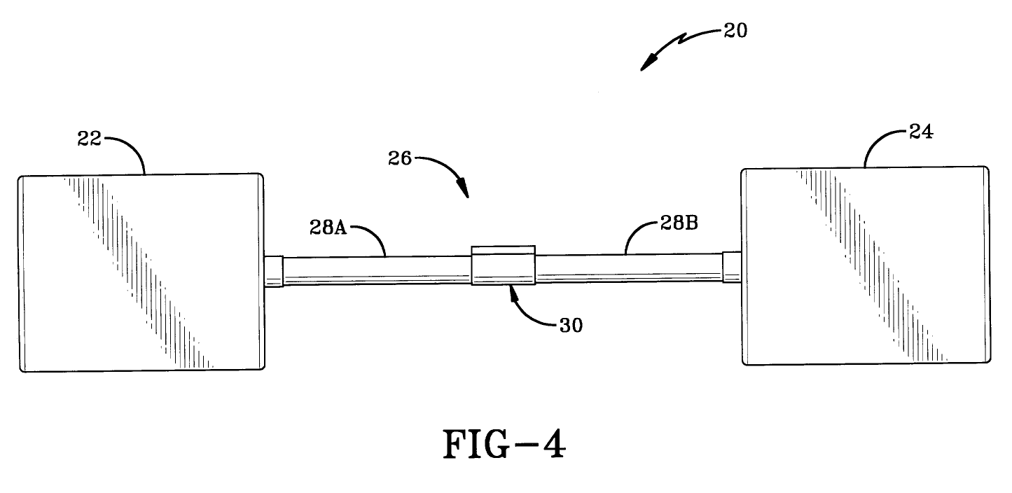

Referring to the drawings, wherein like numerals represent like parts throughout the several views, there is generally disclosed in FIG. 4 a system 20 where it is desirable to move materials in a low pressure or low vacuum environment from a first point 22 to a second point 24 via an enclosed passage 26. The enclosed passage 26 may require more than one length of pipe, in this case pipe length 28A and 28B which must be coupled together using the coupling 30 of the present invention.

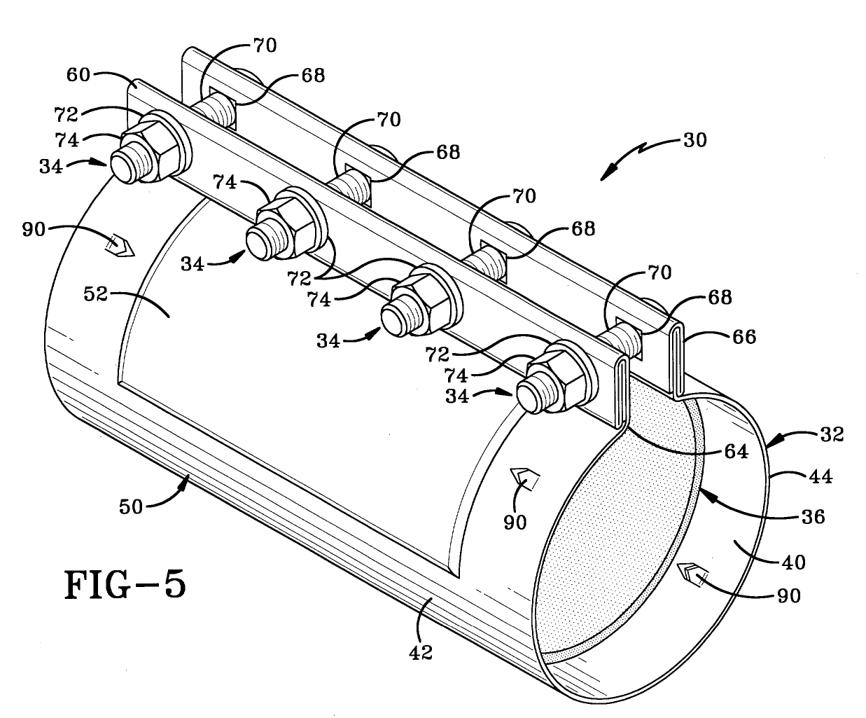

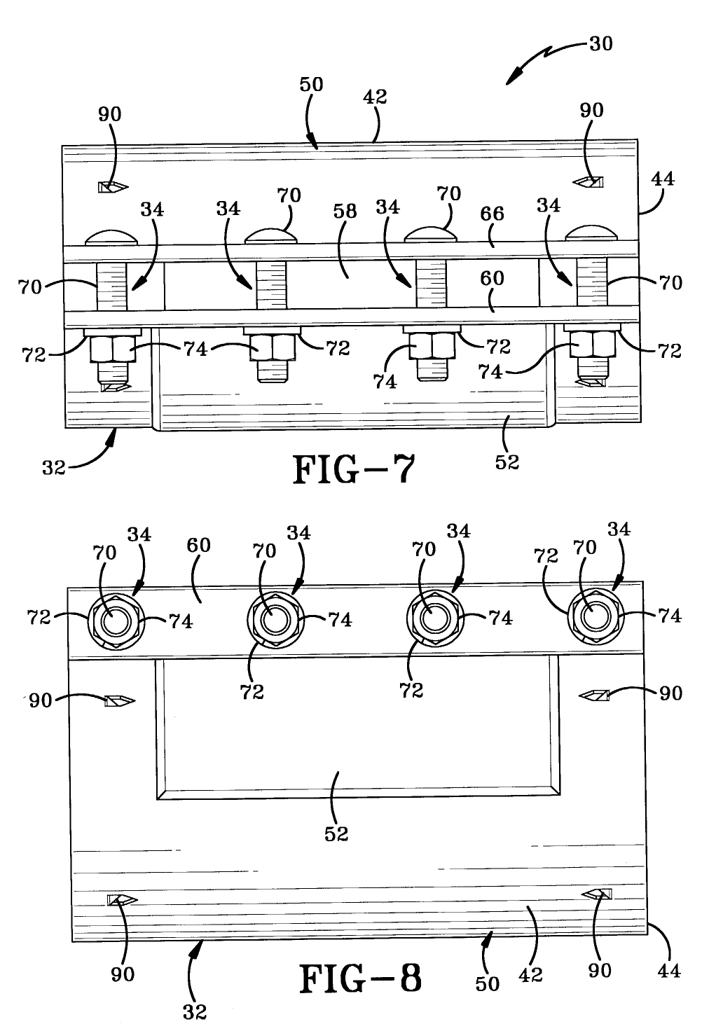

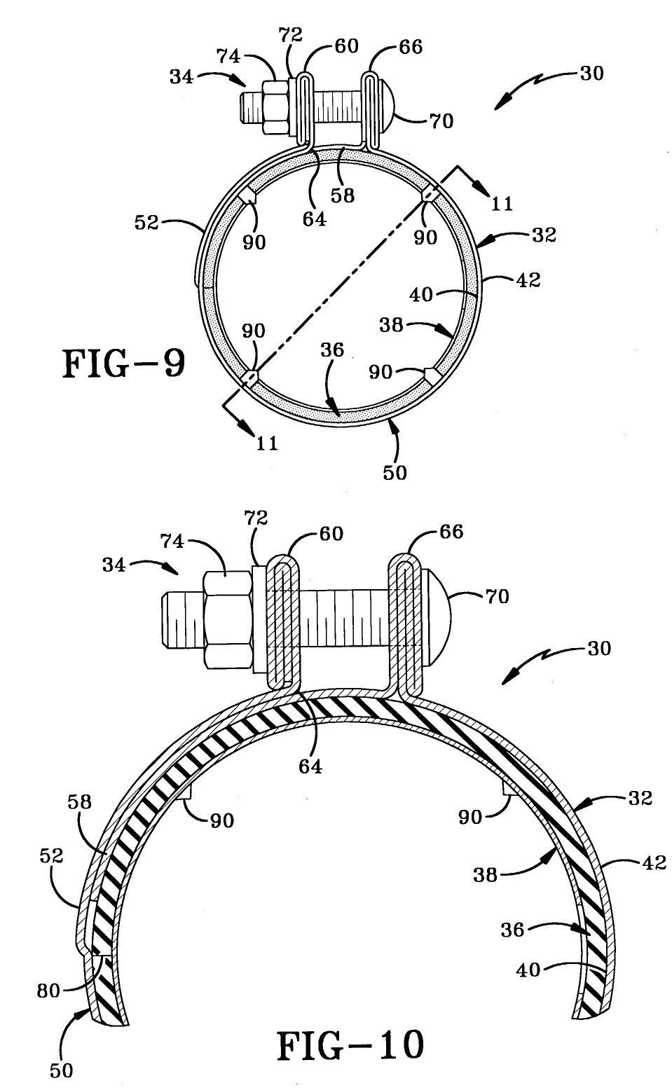

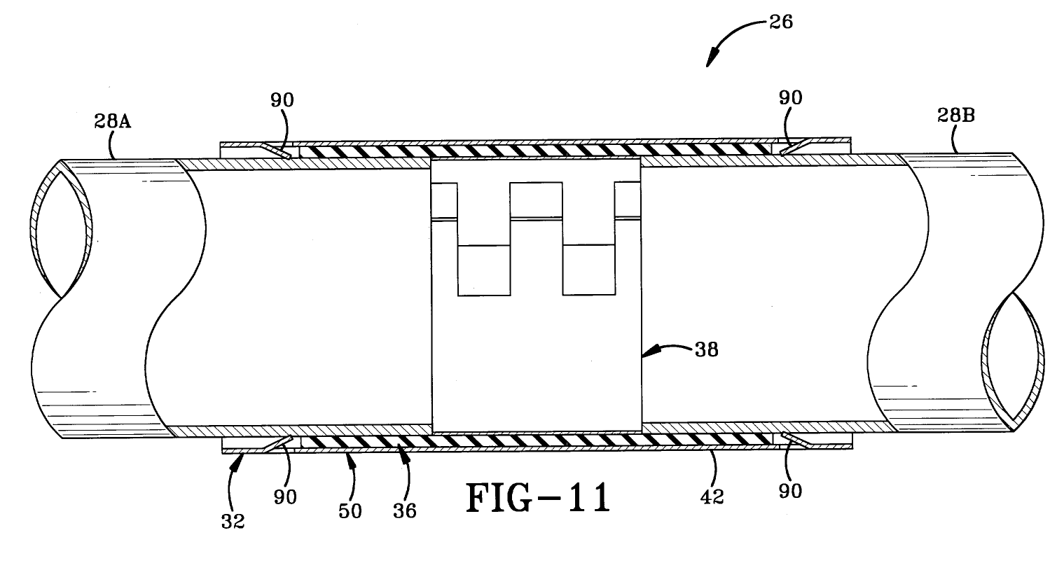

As best shown in FIGS. 5-9, coupling 30 includes a metal sleeve 32, a plurality of fasteners 34, and a liner 36. Coupling 30 may also optionally include an insert spring 38.

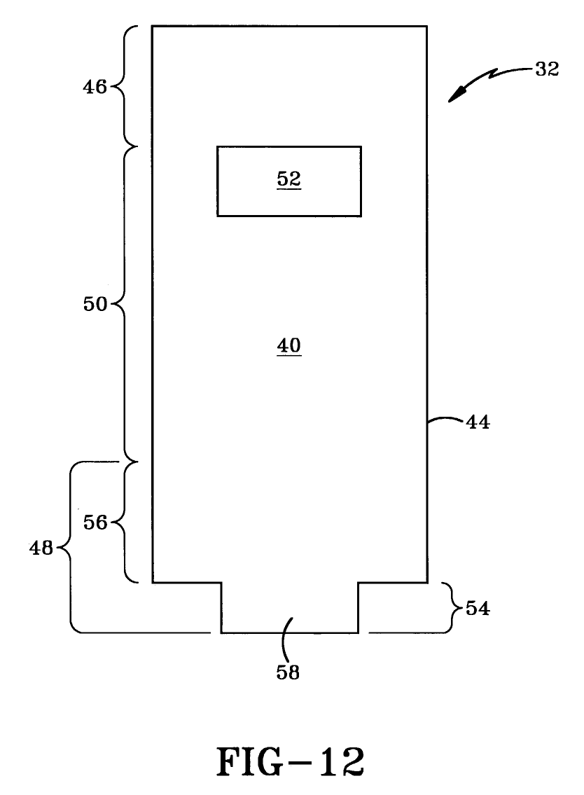

In more detail, sleeve 32 is initially cut or otherwise made in the shape shown in FIG. 12 whereby it is a flat metal sheet with a front surface 40 (which eventually forms the inside surface of the metal sleeve of the coupling), a back surface 42 (which eventually forms the outside surface of the metal sleeve of the coupling), and a thin peripheral edge 44 therebetween. The front and back surface are basically defined by a first end area 46 and a second end area 48 with a mid-section 50 therebetween. Adjacent the first end area 46 within the mid-section is a notched area 52 that is recessed or indented when viewed from the front surface 40 while raised or protruding when viewed from the back surface 42 so as to not be planar with either surface. The second end area 48 is divided into a first section 54 and a second section 56 where the first section 54 is trimmed or otherwise created such that it defines a tab 58 that is of a lesser width than the second section 56 which is of the same width as the mid-section 50 and the first end area 46.

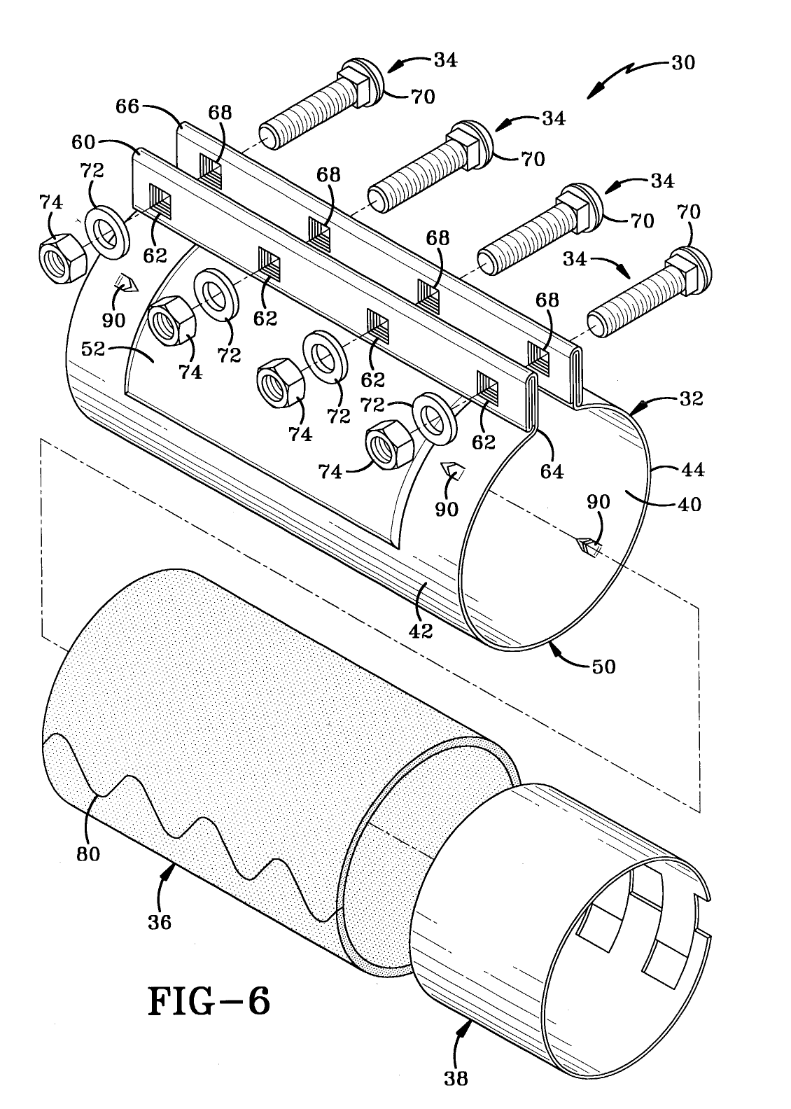

The flat metal sheet of FIG. 12 is formed into the metal sleeve 32 that is shown in FIGS. 5-9. Specifically, the first end area 46 is folded around itself several times and crimped so as to form a first reinforced end 60 which includes a plurality of fastener passages 62. The folding and crimping are stopped once the notched area 52 is positioned just into the bend 64 so as to provide in effect a slot in which the tab 58 will fit as explained below and shown in FIG. 9. The mid-section 50 is formed into a substantially cylindrical body as shown in FIGS. 5-9 whereby the cylindrical body includes the notched area 52 which extends out from therefrom as shown in FIGS. 5-6. The second section 56 of the second end area 48 is folded around itself several times and crimped similar to the first end area so as to form a second reinforced end 66 which includes a plurality of fastener passages 68; however, the first section 54 of the second end area 48 is not folded or crimped and rather extends outward as the tab it is and is alignable and insertable within the notched area 52 via the slot.

Fasteners 34 may be any form of fastener capable of pulling the first reinforced end 60 and the second reinforced end 66 closer together thereby reducing the diameter of the metal sleeve 32 across its mid-section 50. In one embodiment, the fasteners 34 include bolts 70, washers 72 and nuts 74.

Liner 36 may be any form of a sealable material such as rubber and of any design capable of sealing the outer surface of any pipe length such as 28A to the inner surface 40 of the metal sleeve. In the embodiment shown, the liner is a rubber liner and it includes a serrated, toothed, stepped, wavy, linear, or other cut 80 therein.

The optional insert spring 38 is typically some form of a spring designed to spring outward from a central axis so as to push the liner 36 against the inner surface 40 of the sleeve 32. In the embodiment shown, the spring 38 is a cylinder that is squeezable for insertion within the sleeve whereby it springs back once released.

The sleeve 32 may also include one or more spikes 90 extending inward from the sleeve proximate each end thereof. These spikes are designed to engage with the pipe to both assist in holding the pipe within the coupling as well as provide for static electricity flow.

In use, a pipe length such as 28A is placed in one end of the coupling 30, and a second pipe length such as 28B is placed in the other end of the coupling 30. In both instances the end of the pipe length to be sealed is surrounded by the liner 36 which is surrounded by the sleeve 32. Spring 38 may be within the coupling to hold the liner in place. The fasteners 34 are engaged such that the first reinforced end 60 and the second reinforced end 66 are pulled closer together thereby securing the pipe lengths within the coupling. The liner seals the system so as to provide for a low pressure seal between the pipe lengths.

The tab 58 seats within the notched area 52 such that the sleeve 32 maintains a round cross section thereby eliminating stress points. This is best shown in FIGS. 9 and 10 as FIG. 10 is cross section taken through the notched area 52.

In a different embodiment the tab 58 is not part of the sleeve body 32, and instead is a separate body that is fastened to the second reinforced end 66 and provides the same tab-like body to finish out the cylindrical shape of the sleeve and seat within the notched area 52.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described. Other modifications of the invention will be apparent to those skilled in the art in light of the foregoing description.

Having now described the features, discoveries, and principles of the invention, the manner in which it is constructed and used, the characteristics of the construction, and the advantageous new and useful results obtained; the new and useful structures, devices, elements, arrangements, parts, and combinations are set forth in the appended claims.

1. A coupling for coupling multiple passages together, the coupling comprising:
a substantially cylindrical sleeve having an inner surface including a recess therein; and
the cylindrical sleeve having a first end area and a second end area, the second end area including a tab extending therefrom selectively alignable and insertable within the recess.

2. The coupling of claim 1 further comprising a liner positioned along the inner surface of the sleeve.

3. The coupling of claim 2 wherein the liner is a rubber seal.

4. The coupling of claim 2 wherein the first end area and the second end area are at opposite diametrical ends of the cylindrical sleeve.

5. The coupling of claim 4 wherein the first end area includes a first reinforced area, and the second end area includes a second reinforced area, and the substantially cylindrical sleeve includes a mid-section between the first and second reinforced areas whereby the mid-section defines the substantially cylindrical nature of the sleeve.

6. The coupling of claim 5 wherein the first end area is folded around itself several times to define the first reinforced area, and second end area is folded around itself several times to define the second reinforced area.

7. The coupling of claim 6 wherein the first and second reinforced areas extend substantially radially from the respective opposite diametrical ends of the substantially cylindrical sleeve.

8. The coupling of claim 7 wherein the tab extends from the second reinforced end in a substantially circumferential manner.

9. The coupling of claim 8 wherein the tab substantially completes the cylindrical nature of the sleeve.

10. The coupling of claim 9 wherein the tab selectively seats within the recess in such a manner so as to define a substantially round inner surface to the sleeve when viewed in cross section.

11. The coupling of claim 5 wherein the first and second reinforced areas extend substantially radially from the respective opposite diametrical ends of the substantially cylindrical sleeve.

12. The coupling of claim 11 wherein the tab extends from the second reinforced end in a substantially circumferential manner so as to substantially completes the cylindrical nature of the sleeve.

13. The coupling of claim 12 wherein the tab selectively seats within the recess in such a manner so as to define a substantially round inner surface to the sleeve when viewed in cross section.

14. The coupling of claim 13 further comprising fasteners for selectively pulling the first and second reinforced areas closer together.

15. The coupling of claim 14 further comprising a spring positionable inside of the liner to force the liner against the inner surface of the sleeve.

16. The coupling of claim 2 further comprising spikes extending outward from the inner surface of the sleeve adapted to assist in the securing of the passages therein.

17. A method of connecting adjacent pipes, the method comprising:
overlapping a recess along an inner surface adjacent a first end area in a substantially cylindrical sleeve with a tab extending from a second end area in a substantially cylindrical sleeve such that the tab is selectively alignable and insertable within the recess;
inserting a pair of pipes within the substantially cylindrical sleeve such that an outer surface of each pipe is covered by a liner that is positioned along the inner surface of the substantially cylindrical sleeve; and
pulling the first and second end areas toward one another while thereby clamping the pipes within the coupling.

18. A coupling for coupling multiple passages together, the coupling comprising:
a substantially cylindrical sleeve having an inner surface, including a recess therein; and
the cylindrical sleeve having a first end area and a second end area, the second end area including a tab extending therefrom selectively alignable and insertable within the recess and at least one spike extending outwardly from the inner surface of the sleeve and adapted assist in the securing of the passages therein.
